(19) United States
(12) Patent Application Publication
(10) Pub. No.: US 2006/0213310 A1
(43) Pub. Date: Sep. 28, 2006

(54) Cable operated control mechanism comprising an elastically deformable cable control assist member

(76) Inventor: Daniel Bignon, Villejuif (FR)

Correspondence Address: HEDMAN & COSTIGAN P.C., 1185 AVENUE OF THE AMERICAS, NEW YORK, NY, 10036, US

(21) Appl. No.: 10/564,739

(22) PCT Filed: Jul. 7, 2004
(86) PCT No.: PCT/FR04/01760

§ 371 Date: May 1, 2006

(30) Foreign Application Priority Data
Jul. 18, 2003 (FR) 03/08761

(51) Int. Cl. F16C 1/10

(52) U.S. Cl. 74/502.2

(57) ABSTRACT

The invention relates to a cable (4)-operated mechanism which is used to control a remote member and which is intended for civil engineering machinery or similar. The inventive mechanism consists of a casing (3) housing a control member comprising a proximal end forming a lever (1) which is articulated to the casing (3) and which is used to control the cable (4). The aforementioned control member consists of at least two abutting segments which are articulated to one another, namely: a proximal segment which forms the lever, and a distal segment comprising an elastically-deformable member which rests against the casing in order to form a lever control assist member.

The present invention relates to the field of cable-operated control systems for controlling a remote member. It is directed to a mechanism of the kind used to operate a remote hydraulic member, particularly for such a member functioning as part of a relatively high-pressure hydraulic system.

It will be recalled that in general, it is known to remotely control the operation of a hydraulic member, such as a distributor or the like, by means of a cable-operated control mechanism. The prior art includes such common mechanisms, which employ a control stick that is articulated to a casing and can be manipulated by a user to operate the cable.

Variants are routinely proposed, depending on the conditions of use of the remote member to be operated, and depending more particularly on the hydraulic power against which it is necessary to act in order to operate the remote member. In cases where the hydraulic power is relatively low, the cable is directly in relation to the remote member to be operated. In cases where the hydraulic power is relatively high, the cable is in relation to an intermediate member for operating the remote member, which intermediate member utilizes an auxiliary power source. More particularly, this intermediate member, such as a servomechanism, is interposed between the cable-operated control mechanism that operates it and the remote member that the intermediate member operates in turn.

A user wishing to remotely control a hydraulic member is therefore constrained to choose what type of control mechanism is to be used on the basis of the hydraulic power against which the remote member must be operated. The attendant costs are naturally taken into account in this choice, the use of a control mechanism comprising an auxiliary member and power source for operating the remote member entailing a higher installation cost. Experience has shown that although the user is obviously forced to make such a choice when the hydraulic powers in question are manifestly high or low, the issue is more complex when the hydraulic power under consideration is an intermediate power between these high and low levels, or when the assistance gained by using an intermediate member to operate the remote member resides merely in convenience for the user. Nevertheless, habit and prejudice in this field tend to favor the use of an intermediate member powered by an auxiliary source to operate the remote member, even when the hydraulic powers in question are intermediate between the above-cited high and low levels.

Cable-operated control mechanisms for construction machinery have been proposed that include a lever articulated to a frame and equipped with an elastically deformable member, such as a gas cylinder or spring cylinder. The reader is referred, in particular, to the documents EP0443828 (BAMFORD EXCAVATORS LTD) and U.S. Pat. No. 2,329,898 (HENNING, RAYMOND) describing such mechanisms, which are widely used to operate brake mechanisms. The gas spring is articulated at its ends to the frame and to the lever such that the operation of the lever is facilitated for the user, in contrast to the effort that must be applied to operate the hydraulic member.

The arrangement of these mechanisms precludes merely replacing them with cable-operated mechanical control mechanisms comprising a control member whose proximal end forms a control stick that is articulated at least pivotably, if not omnidirectionally, to a casing, such acs mechanisms of the kind described in the documents EP0458313 (MEFLEX) and FR2678082 (T.M.C.). In this type of mechanism, the casing houses the control member, whose proximal end, forming the control stick and emerging from the casing so that it can be grasped by the user, comprises a grip so that it can be operated movably between an idle position and at least one working position, in which working position the cable acts against a resisting force exerted by the remote member to be operated. The control stick is further connected to a cable-operating member that is housed inside the casing and to which the cable is anchored, such that in working position the cable exerts effective traction on the remote member.

It will be noted that such prior-art cable-operated control mechanisms include more particularly the “joystick” type, in which the control stick is articulated omnidirectionally to the casing, so as to exert a both tractive and compressive force on the cable to operate the remote member that is to be operated.

It will be appreciated that the overall dimensions of the casing housing the mechanism should be limited and that it is desirable to keep the structure of the mechanism simple, not only to avoid increasing its dimensions, but also so as to offer ease and convenience of use at the lowest possible cost price. These constraints therefore rule out the use of a control-stick maneuvering assist arrangement similar to the type of lever maneuvering assist arrangement used in the mechanisms described in EP0443828 and U.S. Pat. No. 2,329,898, and the aforesaid habits and prejudices in this field are thereby encouraged, particularly in the direction of offering an ergonomics for the mechanism that is satisfactory to the user.

The object of the present invention is to propose a cable-operated control mechanism of the above-cited type described in EP0458313 and FR2678082, for controlling a to-be-operated remote hydraulic member for a construction machine or the like, which makes it possible to operate such a remote member directly by means of the cable against a relatively high power while at the same time offering limited overall dimensions and a simple structure for the mechanism, which is to be housed in a casing, and an ergonomics that provides satisfactory ease and convenience of operation for the user. The present invention is aimed more particularly at proposing such a cable-operated control mechanism that is applicable to a joystick, in which the control stick is articulated omnidirectionally for the cable to act indifferently in traction and in compression.

The inventive step of the present invention was to break with the habits that have been acquired in the field, by proposing a cable-operated control mechanism of the aforesaid kind in which the mobility of the control member housed inside the casing, during its changeover from its idle position to a working position operative to exert on the cable either one of at least a tensile force and a compressive force, is boosted by an elastically deformable assist member that forms part of the control stick of the control member. The control stick and the elastic member are abutted so as to be placed in prolongation of each other, the control stick bearing at its base against the elastically deformable member to keep it under stress in the idle position and to release it in working position against a resistance exerted by the remote member to be operated. The effort applied to the control stick by the user is limited to the effort needed to move it directionally, whereas the prestressed member, when the control stick is in idle position, bears against the latter to supply the power necessary to maneuver the cable against the resistance of the remote member to be operated, within a reasonable limit falling in particular between the aforesaid high and low powers.

More precisely and according to the present invention, the control member is composed of at least two abutting segments articulated to each other. A first, proximal segment constitutes said control stick, while a distal segment is formed of an elastically deformable member that bears articulatedly against the casing to constitute an assist member for the operation of the control stick. These measures are such that in idle position, the control stick and the assist member are disposed in prolongation of each other to place the assist member under stress, and the passage from this idle position to a working position is achieved by tilting the control stick, which is then pushed at its base by the assist member articulated to the casing.

It will be noted more precisely that the assist member is interposed between the casing and the control stick, and that when the latter is in idle position, the assist member is disposed in the prolongation of the control stick, with which it is oriented coaxially for purposes of being placed under stress, such that a tilting of the control stick by the user breaks said coaxial alignment to release the assist member, which in turn operates the control stick by thrust, the action of the user on the control stick thus being limited to keeping the latter in a desired tilted position.

As a result of these measures, without any attendant increase in the complexity of the structure and the overall dimensions of the control member, which is composed simply of at least two abutting segments, the user has the use of a cable-operated control mechanism offering proper ease and convenience of use, while the fact of the control stick bearing against the assist member via its distal end optimizes the utilization, by the lever effect, of the force exerted by the assist member on the control stick during the operation of the cable.

Such a relative configuration of the control stick, the assist member and the casing predisposes the mechanism proposed by the present invention to a joystick-type cable-operated control mechanism, in which the control stick is articulated omnidirectionally to the casing and in which the cable acts both in traction and in compression. It will be understood, however, that such predispositions are not limitative of the scope of the present invention and the applications of it that can be made, and that the arrangement of the articulation of the assist member is consociate with the articulatory mobility of the control stick on the casing, particularly unidirectionally or omnidirectionally, depending on the area of application of the invention and the associated configuration of the articulation of the control stick on the casing, as a lever or a joystick.

In variant embodiments, the assist member is any one of the devices in the group of devices comprising compression springs and gas cylinders or the like.

In a preferred variant embodiment, the assist member is a gas cylinder that is articulated at its corresponding bottom and head ends to a respective one of the casing and the control stick.

In the case where the assist member is articulated omnidirectionally to the casing and to the control stick, the connection of the assist member thereto is preferably effected by means of respective ball joints.

The present invention will be better understood and details relating to it will emerge from the following description of a preferred embodiment, made with reference to the figures on the accompanying plates, wherein:

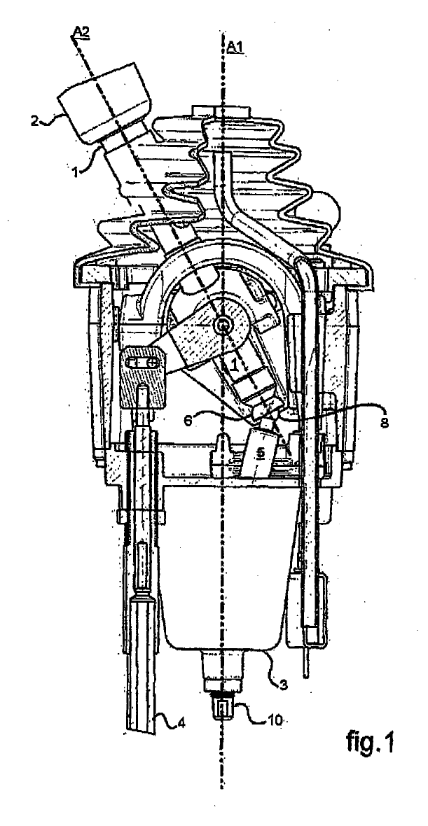

FIG. 1 is a longitudinal sectional view, along a first transverse plane, of a cable-operated control mechanism according to a preferred embodiment of the invention.

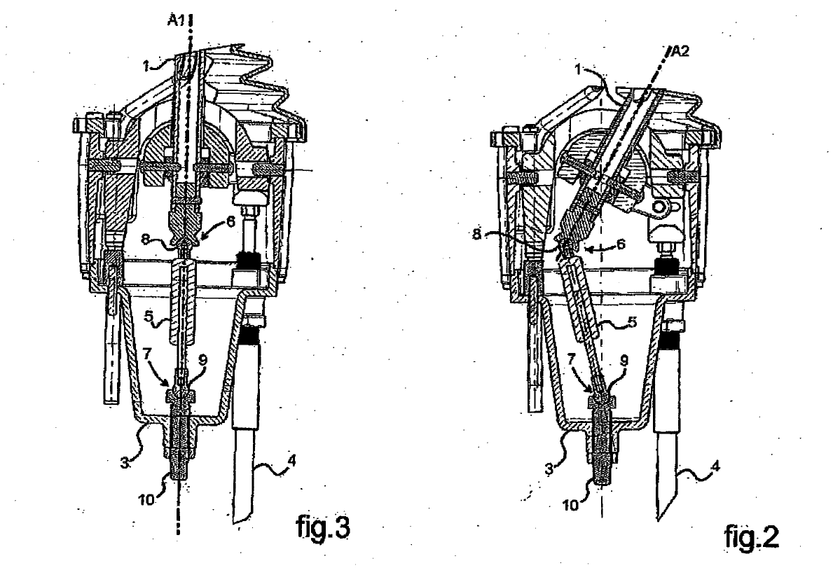

FIGS. 2 and 3 are longitudinal sectional views, along a second transverse plane orthogonal to the preceding, of the cable-operated control mechanism depicted in FIG. 1.

In the figures, a cable-operated control mechanism chiefly comprises a control stick 1 provided at its distal end with a grip 2, not visible in FIGS. 2 and 3. This control stick is articulated to a casing 3 and is connected to a cable 4 in order to operate the latter.

To be noted are the usual measures employed in this field for mounting the control stick 1 on the casing 3 via an omnidirectional joint and for mounting the cable 4 on the control stick 1, according to the illustrated suitable application of the mechanism proposed by the present invention to a joystick in which the cable acts both in traction and in compression.

An assist member 5 for assisting the operation of the cable by means of the control stick 1, constituted by a gas cylinder in the exemplary embodiment illustrated, is interposed between the distal end of the control stick 1 and the casing 3. This gas cylinder 5 is ball-jointed 6 and 7 to control stick 1 and casing 3 by its bottom end 8 and its head end 9, respectively. It will be noted that this arrangement of the gas cylinder 5 is preferred in order to limit the risk that the rod will bend, but that, analogously, the gas cylinder can be inverted and the positions of its ends interchanged without thereby violating the rules of the invention as stated hereinabove.

The control mechanism is preferably equipped with means for adjusting the stroke of the assist member 5, which are advantageously constituted by configuring a support member 10 bearing against the casing 3 of the assist member 5 as a member for adjusting the distance separating the ends 8 and 9 thereof 5 from each other.

In the example illustrated, this configuration is constituted by a threaded or similar connection between the casing 3 and the support member 19. Support member 10 preferably emerges from the casing so that the desired adjustment can be performed from outside the casing 3. It will be noted, however, that in a similar manner but one that is not preferred owing to the difficulty of making the desired adjustment, these equivalent measures can be implemented in the region of the support of assist member 5 on control stick 1.

In FIG. 3, control stick 1 is in idle position, that is, it is not exerting any action on cable 4, either in traction or in thrust, particularly.

It will be noted that as is customary in this field, control stick 1 is spontaneously held in idle position by immobilizing or locking means (not shown in the figures). In this idle position, control stick 1 and gas cylinder 5 are disposed in prolongation of each other, such that gas cylinder 5 is placed under stress with the rod in an at least partially retracted position.

In FIG. 1 and FIG. 2, control stick 1 is in working position, i.e., it is exerting a force, in thrust or in traction, on cable 4 to directly operate a remote power member (not shown in the figures). Control stick 1 is moved by the user until it is tilted on an axis A2 that coincides with general axis A1 for orienting the control stick in idle position, as is customary in this field. This movement of the control stick by the user, however slight it may be, breaks the alignment between control stick 1 and assist member 5, causing the release of the latter. The power thus developed by assist member 5 is used to exert on control stick 1 a force capable of causing the operation of cable 4 against the resistance offered by the remote member, the user's effort thus being limited solely to guiding control stick 1 into position.

Referring to either of FIGS. 1 and 2, it will be noted that the assistance to the operation of cable 4 can take place regardless of the spatial orientation of the tilt A2 of control stick 1, due in particular to the abutment of control stick 1 with assist member 5 and to the ball-joint mounting 6 and 7 thereof 5 used to connect it to control stick 1 and casing 3. Furthermore, the fact of control stick 1 resting on assist member 5 by its distal end optimizes the utilization, by the lever effect, of the force exerted by assist member 5 on control stick 1 when cable 4 is operated.

1. A cable (4)-operated control mechanism used to operate a remote member and intended for a construction machine or the like, of the type of mechanism comprising a casing (3) housing a control member from which emerges the proximal end of said control member, forming a control stick (1) configured as a grip (2) to be grasped by the user in order to be maneuvered between an idle position (A1) and at least one working position (A2) in which said cable (4) acts against a resisting force exerted by said remote member to be operated, said control stick (1) being articulated to said casing (3) so that it is movable between said positions and being connected to an operating member for operating said cable (4) that is housed inside said casing (3) and to which said cable (4) is anchored, wherein the
said control member is composed of at least two abutting segments articulated to each other, namely a proximal segment constituting said control stick (1) and a distal segment formed of an elastically deformable member that bears articulatedly against said casing (3) to constitute an assist member (5) for assisting the operation of said control stick (1), such that in idle position, said control stick (1) and said assist member (5) are disposed coaxially in prolongation of each other so as to place said assist member (5) under stress, and in that the changeover from said idle position to a working position is effected by tilting said control stick (1), which is then pushed at its base by said assist member (5).

2. The cable-operated control mechanism of claim 1, wherein said assist member (5) is a device comprising compression springs and gas cylinders.

3. The cable-operated control mechanism of claim 1, wherein
said assist member (5) being a gas cylinder, it (5) is articulated at its corresponding bottom (8) and head (9) ends to a respective one of said casing (3) and said control stick (1).

4. The cable-operated control mechanism of claim 1, wherein
said assist member (5) is articulated omnidirectionally to said casing (3) and to said control stick (1) by means of respective ball joints (6,7).

5. The cable-operated control mechanism as of claim 1 wherein
it is equipped with means (1) for adjusting the stroke of said assist member (5).

6. The cable-operated control mechanism as in claim 5, wherein
said means for adjusting the stroke of said assist member are constituted by configuring a support member (1) bearing against the casing of said assist member (5) as a member for adjusting the distance separating the ends (8, 9) thereof (5) from each other.

7. The cable-operated control mechanism as in claim 6, wherein
the configuration of said support member (1) to permit adjustment of the stroke of said assist member (5) is constituted by a treaded connection between said support member (5) and said casing (3) from which it emerges, so that the desired adjustment can be made from outside said casing (3).
